(19) United States
(12) Patent Application Publication
(10) Pub. No.: US 2012/0095882 A1
(43) Pub. Date: Apr. 19, 2012

(54) Method and Apparatus for Providing Point-of-Sale Product Information to Consumers of Alcoholic Beverages

(76) Inventor: Todd Wayne Wolff, Boerne, TX (US)

(21) Appl. No.: 13/274,340

(22) Filed: Oct. 16, 2011

Related U.S. Application Data
(60) Provisional application No. 61/393,371, filed on Oct. 15, 2010.

(51) Int. Cl. G06Q 30/00

(52) U.S. Cl. 705/27.2

(57) ABSTRACT

A method and apparatus for providing product information to a potential purchaser of alcoholic beverages while the purchaser is shopping within the context of a retail establishment, including: a step or means for identifying the retail establishment within which the purchaser is physically located; a step or means for displaying to the purchaser a list of alcoholic beverage items offered for sale by the identified retail establishment; and a step or means for displaying product information which describes an alcoholic beverage item selected by the purchaser from the displayed list of items offered for sale; whereby the product information is used by the purchaser to make better, more informed purchasing decisions.

### CROSS REFERENCE TO RELATED APPLICATIONS

This application claims priority to U.S. Provisional Application 61393371 entitled “A Method and Apparatus for Providing Point of Sale Information on Alcoholic Beverages and for Collecting Customer Feedback,” filed on Oct. 15, 2010, which is incorporated herein by reference.

### BACKGROUND OF THE INVENTION

Choosing the appropriate alcoholic beverage to go with a meal, especially if that beverage happens to be wine, can be difficult and, at times, even intimidating. The wine list at a typical restaurant often includes dozens of selections and in some cases may include upwards of 100 or more. Within the aisle of a grocery store, liquor store, etc. . . . , the selection may represent several hundred different choices. To further complicate the situation, the consumer must often make the appropriate selection in a relatively short period of time. Even for experienced patrons making the right decision consistently can be difficult. To help improve the quality of their selections, the consumer needs timely and relevant product information provided to them at the point-of-sale. While some retail establishments provide on-site product experts, e.g. a sommelier, etc. . . . , which provide this type of information; most consumers are self-conscious about their lack of product knowledge and therefore fail to ask for assistance. Furthermore, for those retail establishments which are unable to afford the cost of an on-site product expert, training existing staff to fill this role can be difficult and often ineffective. This lack of consumer knowledge can have a negative impact on the producers and retailers of alcoholic beverages as well. Studies have shown that having under informed customers translates into lower sales. Customers who make poor choices are often less satisfied with their overall dining experience, shopping experience, etc. . . . , and are therefore less likely to return.

The current state of the art does little to help solve this problem. While there are currently available mobile applications, web-sites, etc. . . . , which are designed to help the general public learn about and make more informed alcoholic beverage selections, these applications are not specifically designed to be used at the point-of-sale, e.g. when ordering wine at a restaurant or when making a selection from an aisle in a grocery store, a liquor store, etc. . . . Because these mobile applications and web-sites are not specifically designed to be used by customers at the point-of-sale, attempting to use them within this context would be a frustrating experience for the user. As an example, for those mobile applications and web-sites that allow consumers to query specific products by name, the customer would have to type the name (or scan the item's barcode if available) for each item offered for sale by that specific establishment to narrow the selection down to a short list of candidate items. For those applications and web-sites without the ability to query specific brands, the application instead begins with a database of all selections within the “known universe” and allows the user to “filter” the database by, e.g. type, origin, taste preference, etc. . . . When using this type of mobile application or web-site, the customer would have to hope that the resulting filtered list of beverage items contains a selection which is actually offered for sale by that particular retail establishment.

Another related problem, which the current state-of-the-art fails to help retail establishments solve, is how to determine the appropriate list of alcoholic beverage items offered for sale and the pricing of those items, e.g. a restaurant's wine list, the items displayed at eye level within a grocery aisle, etc. . . . Determining the appropriate sales mix and pricing of alcoholic beverages can have a significant impact on a retailer's profitability. For restaurants the challenge is especially important. For this type of business, the percentage of alcoholic beverage sales, as compared to total sales, can be as high as 40% or more. Additionally, because the profit margin on alcohol sales is much higher than the profit margin on food sales, the effect that mismanagement of these items can have on the overall profitability of the restaurant can be significant.

In terms of technology, there are few resources available to assist management with this effort. The current state-of-the-art is focused on inventory management and loss prevention and in some cases performs a contribution margin analysis on the items sold, i.e. by tracking the total sales per item and the associated costs of goods sold. While knowing each item's contribution margin is an important part of “engineering” a retail establishment's product list, e.g. a restaurant's wine list, etc. . . . , the current state-of-the-art fails to provide management with a critical component in the overall analysis. The current state-of-the-art fails to explicitly factor customer preference into the decision making process.

Without explicit, customer feedback, management can only infer which alcoholic beverage selections are actually preferred by the customer. In other words, the best selling items may not necessarily be the items which are most liked by the customer. There are other reasons why one item may be selling better than another. An item's sales may, for example, be artificially inflated due primarily to first time purchases, i.e. as a result of suggestive selling or due to a vendor sponsored advertising campaign. Conversely, for the worst selling items on the menu, without explicit customer feedback, management can only assume that these items are the least preferred by its customers. There are, however, many reasons why an item may not be selling well, i.e. other than because customers simply don't like the way it tastes. Perhaps the majority of customers who purchased the beverage liked it, but felt that it was overpriced in terms of perceived quality. If the alcoholic beverage in question is wine, perhaps the wine was inappropriately paired with the type of food served, or would have sold better if it were sold by the glass. In short, without explicit customer feedback, the decisions made by management, in regards to determining the appropriate sales mix and pricing of an establishment's alcoholic beverage offering, are based partly upon a best guess effort.

In summary, the current state-of-the-art fails to provide consumers of alcoholic beverages with the information they need in order to make better and more informed decisions at the point-of-sale. Additionally, the current state-of-the-art ignores customer preference when determining the appropriate sales mix and pricing of the items offered for sale by an establishment. As a result, the profitability of the associated retail establishment and the overall satisfaction of its customers are diminished.

### BRIEF DESCRIPTION OF THE DRAWINGS

FIG. 1 is a network level diagram which depicts the architecture employed by one exemplary embodiment of the system;

FIG. 2 is a block diagram of an exemplary embodiment of the computing devices defined by the specification;

FIG. 3 is a UML interaction diagram that depicts the coarse grained interactions between the system components within the context of the display product information use case;

FIG. 4 is a wireframe diagram which shows a simplified version of the GUI used to display the list of alcoholic beverage items to the user;

FIG. 5 is a wireframe diagram which shows a simplified version of the GUI used by user to filter the items displayed where the filtered alcoholic beverage type is wine;

FIG. 6 is a wireframe diagram which shows a simplified version of the GUI used to display product information to the user;

FIG. 7 is a UML interaction diagram that depicts the coarse grained interactions between the system components within the context of the capture customer feedback use case;

FIG. 8 is a wireframe diagram which shows a simplified version of the GUI used to display past purchase events to the user;

FIG. 9 is a wireframe diagram which shows a simplified version of the GUI used to display items purchased during selected event;

FIG. 10 is a wireframe diagram which shows a simplified version of the GUI used to capture customer feedback associated with purchased item.

### DETAILED DESCRIPTION OF THE EMBODIMENTS

The present specification discloses a method and apparatus for providing point-of-sale product information to consumers of alcoholic beverages and for collecting customer feedback related to those products purchased by the consumer. Hereafter, details are set forth by way of example to facilitate discussion of the disclosed subject matter, but it will be apparent to those having skill in the art that other variations and embodiments are possible. Certain structures and devices are disclosed in block diagram form to clarify and simplify the disclosure.

### System Architecture Description:

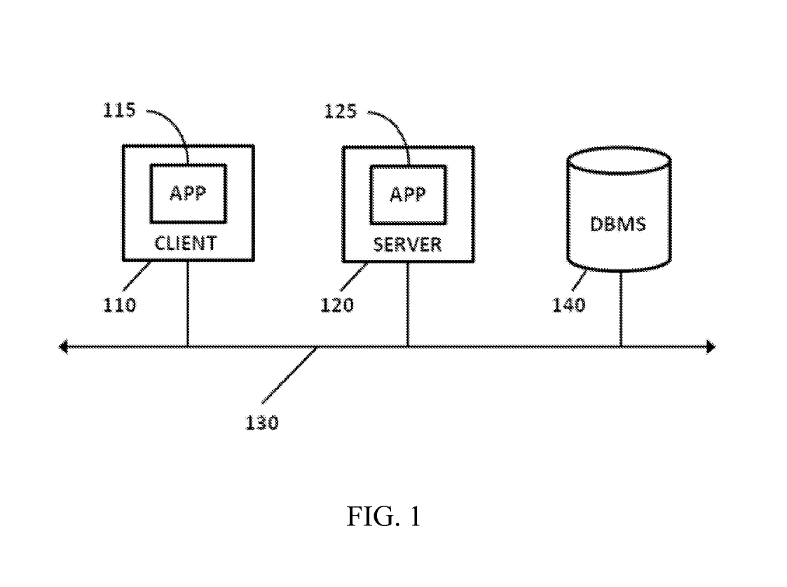

FIG. 1 depicts a simplified view of the physical structure of one exemplary embodiment of the system. As one who is skilled in the art will recognize, the physical structure utilizes a client-server based architecture. This architecture was chosen due to its scalability, i.e. such that the system will continue to perform responsively as more and more users are added. As depicted within FIG. 1, the client 110, communicates with the server 120, over a network 130, where the client's connection to the network is wireless. Within other embodiments, the client 110 may be physically wired to the network 130. The server 120 communicates with a database management system (DBMS) 140, which as depicted within FIG. 1, is located on a separate device, accessible via the network 130. Within other embodiments, a different architectural approach may be utilized which would also be satisfactory. Within other embodiments the server 120 and the DBMS 140 could represent a single device or it could be that the client 110 and server 120 represent a single device, or it could be that the client 110, server 120 and DBMS 140 represent a single device. Regardless of where these components are physically located within the system, the functionality provided by each remains relatively unchanged. Additionally, as one who is skilled in the art will understand, the network 130 could be comprised of both a wide area network and portions of which could be considered to be a local area network, depending upon the physical location of the client 110, the server 120 and the DBMS 140.

Within this embodiment, as depicted within FIG. 1, the client device 110, is a mobile computing device, e.g. a smart phone, a tablet computer, personal data assistant (PDA), a notebook computer or any other form factor which provides the user with a portable, computing device. Within other embodiments, the client device 110 may be a non-portable computing device. A software based application 115 is installed on, and executes within the context of the client device 110. This application, henceforth referred to as the “client app,” provides a graphical user interface (GUI) that is used by the user to interact with the system. The users of the system are potential purchasers of alcoholic beverages who are shopping within the context of a retail establishment including restaurants, bars and mass merchandising establishments (grocery stores, liquor stores, etc. . . . ). Note that the terms “purchaser”, “customer”, “patron” and “consumer” are used interchangeably throughout this specification and all refer to the “user” of the system.

Within this embodiment, the client app 115 is capable of running on the following mobile computing platforms: the IOS platform by Apple Inc., the ANDROID platform by Google Inc., the BLACKBERRY platform by Research in Motion LTD, and the WINDOWS MOBILE platform by Microsoft. Other embodiments may utilize a client app 115 which is capable of running on other mobile computing platforms. Note that at present, there are cross-platform, mobile application development “toolkits” which can be used to facilitate the development of a single mobile application which is capable of running on more than one type of platform including, TITANIUM by Appcelerator Inc. and PHONEGAP by Nitobi Software. This embodiment uses the PHONEGAP toolkit to create an HTML, browser-based GUI. Other embodiments may utilize a different toolkit or may instead develop native applications for the client app, each of which is designed to run on a specific mobile platform or they may use an HTML browser-based UI which is developed without using a cross-platform toolkit, all of which are satisfactory. In any case, a person who is skilled in the art of mobile application development will understand how to use the chosen development approach to develop a mobile application which provides the functionality described herein.

Also depicted within FIG. 1 is a software based application 125 which is installed upon and executes within the context of the server device 120. This application, henceforth referred to as the “server app,” is responsible for responding to requests from the client app 115 and manages the interactions with the DBMS 140 on behalf of the client app 115. As one who is skilled in the art will recognize, other embodiments may indicate that no server app is utilized and that client app 110 instead interacts directly with the DBMS. In any case, the DBMS 140 is responsible for managing the data used by the system. Within this embodiment, the JAVA object-oriented, programming language, which is owned and maintained by Oracle, is used to develop the server app. Other embodiments may use a different programming language, e.g. C, C++, OBJECTIVE C, RUBY, PHP, PYTHON, PERL, etc. . . . , or they may use a combination of languages to implement the server app, which is also satisfactory. As one who is skilled in the art will understand, depending upon the number of users using the system, multiple server devices 120 may be utilized, each of which runs an instance of server app 125 and across which requests from instances of client app 115 (one instance per user) are distributed. Additionally, this embodiment uses MYSQL by Oracle Corporation, to provide the DBMS functionality. Other embodiments may use a different DBMS implementation including ORACLE by Oracle Corporation., SIMPLEDB database by Amazon Web Services LLC, SQL SERVER by Microsoft, INFORMIX by IBM, INGRESS by Ingress Corp, etc. . . . , which are also satisfactory. One who is skilled in the art of database design and development will understand how to use the chosen DBMS implementation to create a database that provides the functionality described herein.

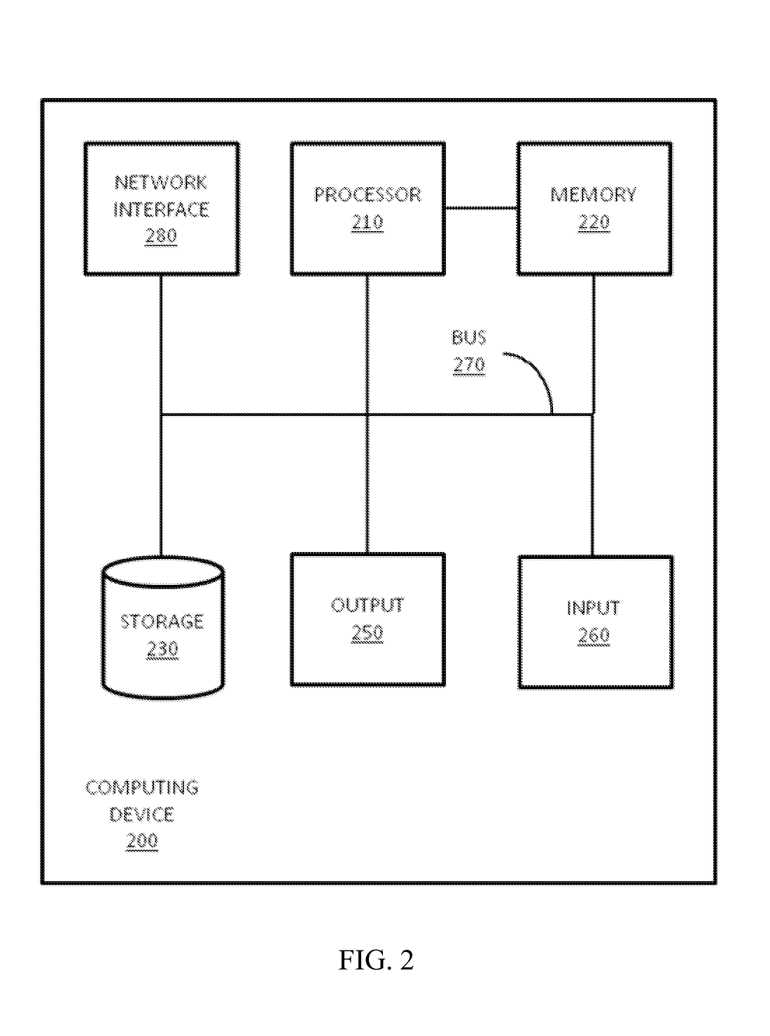

FIG. 2 is a block diagram of an exemplary embodiment of a computing device 200, which describes the computing devices depicted within FIG. 1 in greater detail. The term computing device is used broadly in this specification to represent any type of computer or computing device constructed under the so-called “Von Neumann architecture” and having one or more operable network or data ports. References or examples to computing devices within this specification, including client device 110, server device 120, and the device upon which the DBMS 140 executes should be understood to mean any machine under this definition.

A machine under this definition, as depicted within FIG. 2, is controlled by a processor 210. As used in this specification, the processor may refer to a central processing unit, microprocessor, microcontroller, field programmable gate array, application-specific integrated circuit, or other similar programmable logic device capable of executing software instructions. Software instructions for processor 210 may be held in a memory 220, which in some embodiments may be directly connected to processor 210 in a “direct memory access” configuration. As used in this specification, memory may refer to relatively low-latency, volatile main memory, such as random access memory. In this exemplary embodiment, a distinction is drawn between memory 220, and relatively higher latency storage 230. Storage 230 may be constructed with higher memory density, and may be nonvolatile. For example, storage 230 may be a hard disk drive, flash disk, read-only memory, or other nonvolatile storage medium. Although memory 220 and storage 230 are disclosed as conceptually separate in the present block diagram, in some embodiments, the functions of memory 220 and storage 230 may be combined in a single physical device. For example, some portable computing devices may employ technology such as flash or a battery-operated RAM. In those cases, memory 220 and storage 230 may both be provided by a single physical memory device. Unless otherwise limited, this specification intends to encompass computing devices that have separate memory 220 and storage 230, as well as those that combine the functions of memory 220 and storage 230 into a single physical technology. Software instructions and data may be permanently held in storage 230, and may be loaded into memory 220 for immediate execution. A bus 270 is provided to communicatively couple processor 210 to other components of the computing device 200, such as storage 230, input driver 260, output driver 250, and network interface 280. Input 260 is provided for receiving input from an operator of computing device 200. Output 250 is provided for providing output to the operator of computing device 220. A network interface 280 is provided to communicatively couple the computing device 220 to the network 130.

### Description of First Use Case:

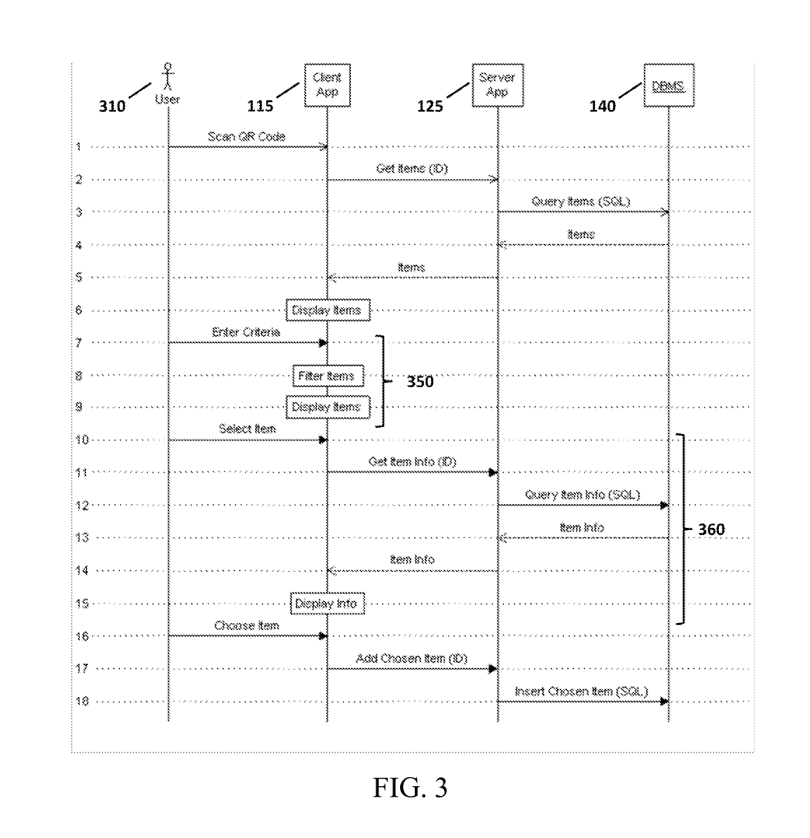

FIG. 3 depicts the coarse grained interactions between the components defined above within the context of a specific use case, i.e. the case where the system is used by a customer to retrieve point-of-sale product information describing alcoholic beverages offered for sale by a specific retail establishment and then use it to subsequently store the items that were purchased for later retrieval. The components which participate in this use case are depicted across the top of the diagram, i.e. along the X axis, while the sequence of interactions are listed in chronological order (numbered 1 through 18) on the left side of the diagram, i.e. along the Y axis. Note that other embodiments may specify a different set of interactions, or may choose to order the interactions differently, and yet still achieve the same end result. Note also, that the specific programming language and operating environment used to implement this embodiment will require that the high level, coarse grained interactions, depicted in this diagram, and the diagrams that follow, be translated into much finer-grained interactions, e.g. as required by a particular application programmer interface (API). For those who are skilled in the art of software development, this concept will be well understood and the approach immediately intuitive.

### Identifying the Retail Establishment:

As depicted within interaction 1 in FIG. 3, the user 310, i.e. the customer, uses the mobile computing device to scan a Quick Reference (QR) Code (a type of matrix barcode), which encodes an ID that is unique to the specific retail establishment within which the customer is shopping for alcoholic beverage(s). Within this embodiment, the ID is a surrogate key which consists of a unique (unique within the context of the DBMS) hexadecimal string of characters. Within other embodiments, the unique ID could be a surrogate key which uses binary, octal or decimal characters or the ID could be a natural key using, e.g. the name of the establishment, the concatenated latitudinal and longitudinal coordinates of the establishment, the concatenated physical address of the location, etc. . . . Within this embodiment, the QR code is conveniently displayed somewhere within the retail establishment, e.g. printed on a wine list, printed on point-of-sale advertising, displayed on product shelving, etc The majority of mobile computing devices available today are equipped with a camera and a barcode scanning application that uses the camera to “read” the QR code and communicate the ID to the client app 115.

In addition to scanning a QR code with the user's mobile computing device, other actions/structures can be used to identify the specific retail establishment including: scanning other symbolic representations of the ID, typing the ID into the client app, having the user type the name and/or physical address of the establishment into the client app and searching for and returning potential matches and having the user select the location (and associated ID) from a list, using global positioning satellite (GPS) technology on the mobile computing device to identify the location of the user/establishment which correlates with a specific ID within the DBMS, using the locations of nearby wireless access points (WAP) and/or cellular towers within the vicinity of the mobile computing device to triangulate the location of the establishment which correlates with a specific ID within the database, having the user select from a list of locations (and associated IDs) within the vicinity of the mobile computing device, having the user select from a list of default establishments (and associated IDs), associating an implicit ID for a specific establishment with the client app such that no choice has to be made, having the user select from a list of establishments (and associated IDs) populated by the user, having the user speak the name of the establishment and/or the physical address of the establishment into voice recognition software which runs on the mobile computing device and using the translated text to look-up a specific ID within the database, having the user speak ID into voice recognition software which runs on the mobile computing device, having the user type the name of the establishment and/or the physical address of the establishment into the client app which is then used to look-up a specific ID within the database, or by using other equivalent structures/actions.

### Displaying the List of Items Offered for Sale by the Identified Establishment:

Within this embodiment, as depicted in FIG. 3, the client app 115 uses the ID to request the list of alcoholic beverage items sold by the identified establishment from the server app 125, as depicted within interaction 2. The server app 125 then generates a structured query language (SQL) statement that the DBMS understands and uses it to query the list of items from the DBMS 140, as depicted within interaction 3. As one who is skilled in the art of database programming will recognize, a simplified version of the SQL that would be required to retrieve the data from the DBMS would be similar to: “Select PRODUCT_ID, PRODUCT_NAME from PRODUCT_LIST where ESTABLISHMENT_ID=‘4A415641’”, where the ID value ‘4A415641’ (which is for illustrative purposes only) is used to identify a specific establishment. Note that other embodiments may use a different database design, i.e. different table names and field names, and yet still achieve the same end result. As one who is skilled in the art of database programming will understand, if other embodiments use a different database design, the SQL statement(s) used would have to be adapted to that particular design. Note also that while this embodiment uses SQL to interact with the DBMS, other embodiments may use other languages, e.g. XQuery, OQL, JPQL, the SimpleDB query language, etc. . . . Regardless of the language used, the DBMS 140 uses the communicated ID to distinguish the items sold by that establishment from alcoholic beverage items sold by other establishments which exist within the database and returns the requested items to the server app 125, as depicted in interaction 4. The server app 125 then returns the list of items to the client app 115, as depicted in interaction 5. The list of items is then displayed to the user via the mobile computing device's display using the GUI provided by the client app as depicted in interaction 6.

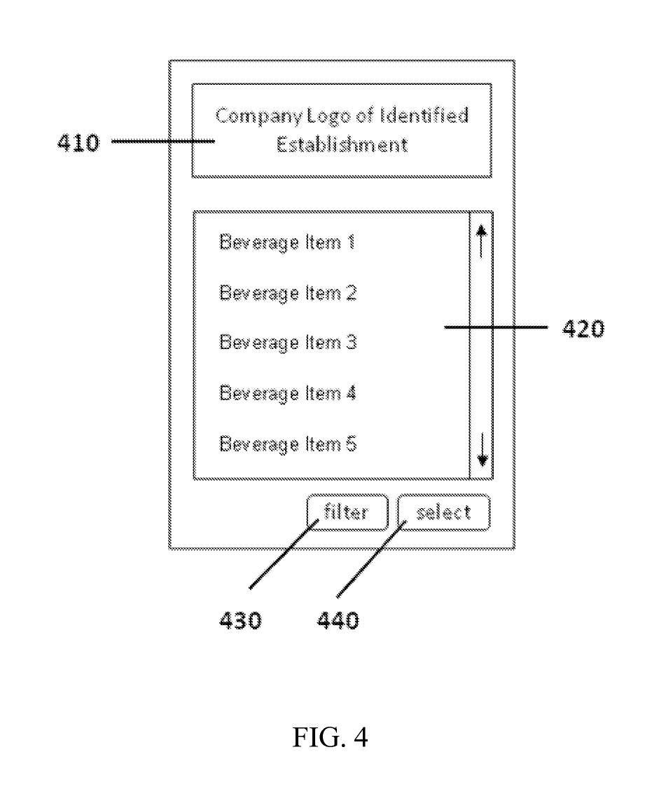

FIG. 4 shows a simplified version of the GUI used within this embodiment to display the items to the user 310. At the top of the screen is the corporate logo of the identified establishment 410, which includes the name of the establishment. The items are displayed within a scrollable list 420 in the center of the screen which can be scrolled by the user by clicking on the up/down errors or optionally by dragging a finger across the list using a vertical motion. Note that other embodiments may use a different GUI, which may include different objects, e.g. additional/different buttons, display panels, images, data items, etc. . . . , arranged on one or more “screens” which are designed to interact with the user and which ultimately serve to display (and optionally categorize) the returned list of items, which is also satisfactory.

### Filtering the List of Items Displayed to the User:

As depicted in FIG. 3, the user 310, may then optionally decide to narrow down the list of items displayed by initiating the three interactions 350, with the client app 115, by entering criteria which is used by the client app 115, to filter, i.e. reduce, the number of alcoholic beverage menu items displayed to the user 310. Continuing with this example, the client app 115 would then use these criteria to narrow the list of beverages sold by the retail establishment to include only those items which match the customer's criteria. The user 310 would optionally continue to repeat these interactions 350, until a short list of candidate alcoholic beverage items which meet the customer's criteria are displayed via the mobile computing device's display.

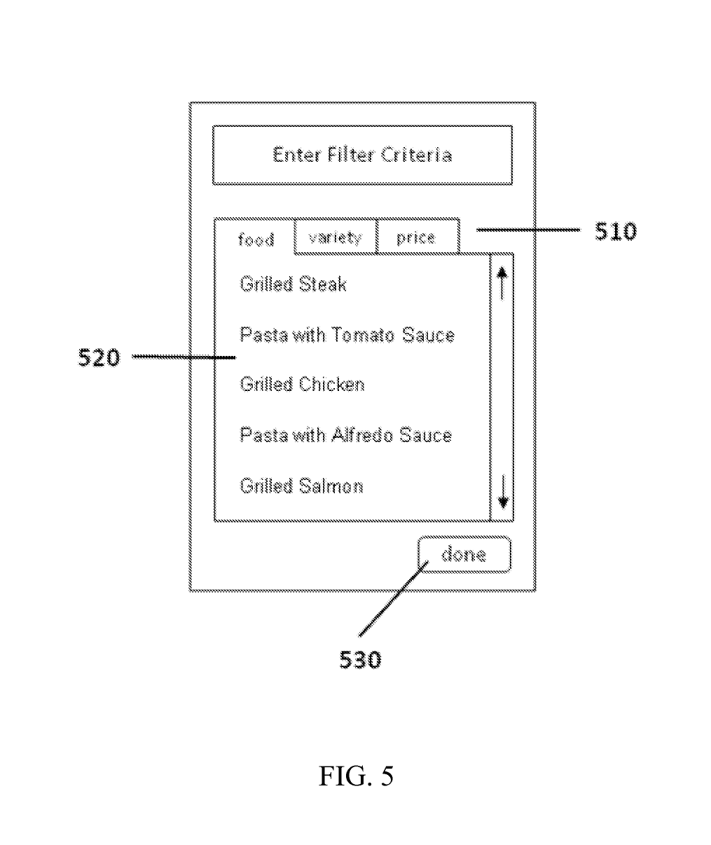

FIG. 5 shows a simplified version of the GUI used within this embodiment to filter the items displayed to the user 310 in the case where the type of alcoholic beverage type targeted by the system is wine. The tabs at the top of the screen 510 group the criteria values into criteria categories, which in this exemplary embodiment the categories include the type of “food” to be paired with the beverage, the beverage “variety” and the “price” range of the beverage. Other embodiments which target wine may utilize other categories of criteria including the growing region, vineyard, vintage, whether the patron prefers to order the wine by the glass or by the bottle, feedback ratings from other users of the system, ratings from wine critics, ratings from other consumers, etc. . . . Other embodiments of the system may target other types of alcoholic beverages, e.g. beer, vodka, tequila, scotch, etc. . . . , in which case, the categories of criteria used will differ according to the targeted beverage type. Within this embodiment, the user 310 highlights value(s) displayed on each tab page 520 and once the appropriate values have been selected, clicks the “done” button 530, which returns the user to the screen depicted in FIG. 4, displaying only those items which meet the selected criteria. Note that other embodiments may use a different GUI, which includes different objects, e.g. additional/different buttons, display panels, images, data items, etc. . . . on one or more “screens” which are designed to interact with the user and which ultimately allow the user to filter the list of displayed items, which is also satisfactory.

### Displaying Product Information for an Item Selected by the User:

As depicted within interaction 10 in FIG. 3, the user 310 selects a specific item for which they would like to receive product information, i.e. information which will help the patron make a more informed purchasing decision. The information describing the selected beverage item is requested from the server app 125 by the client app 115 by passing the ID which uniquely identifies the alcoholic beverage item selected by the user, as depicted in interaction 11. The server app 125 then generates a SQL statement which is understood by the DBMS and the query is issued to the DBMS 140, as depicted in interaction 12. As one who is skilled in the art of database programming will recognize, a simplified version of the SQL that would be required to retrieve the product information from the DBMS would be similar to: “Select * from PRODUCT_INFO where PRODUCT_ID=‘7B435627’” where the wildcard character ‘*’ refers to all available information fields for the indicated product ID and where the ID value ‘7B435627’ (which is for illustrative purposes only) is used to identify a specific product. As one who is skilled in the art of database programming will understand, if other embodiments use a different database design, which is also satisfactory, the SQL statement(s) used would have to be adapted to that particular design. The DBMS 140 then returns the product information associated with the selected item to the server app 125, as depicted in interaction 13. The server app 125 returns the product information to the client app 115, as depicted in interaction 14 and the client app 115, displays the product information to the customer, i.e. the user 310, as depicted in interaction 15 via the GUI.

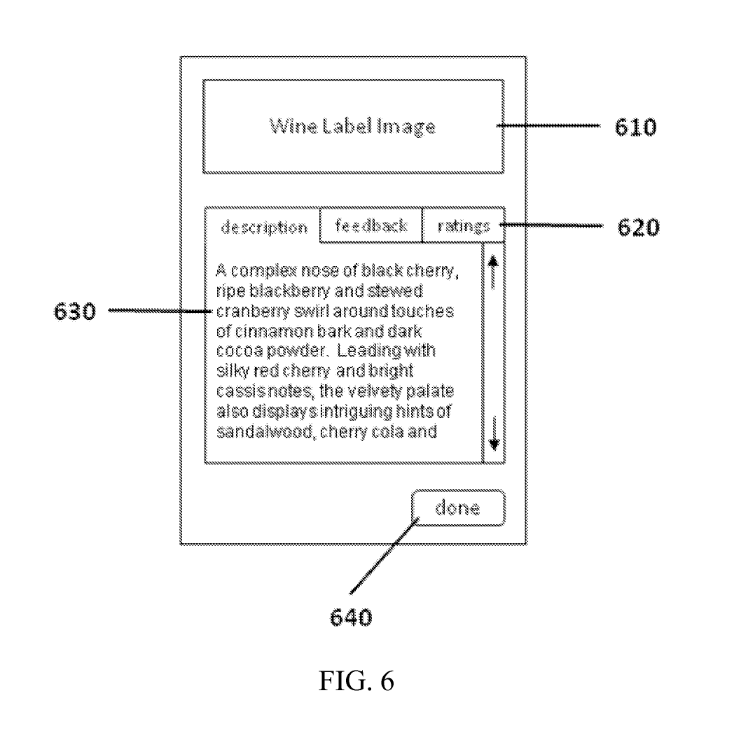

A simplified version of the GUI used by this embodiment to display the product information to the user is shown within FIG. 6. Note that this screen is accessed when the user clicks the “filter” button 430 on the screen depicted within FIG. 4. At the top of the screen, an image of the wine label associated with the selected item is displayed 610. The screen utilizes tab pages 620 to categorize the product information displayed. Each tab page displays the selected type of product information within a scrollable area 630. To return to the previous screen, depicted within FIG. 4, the user clicks the “done” button 640. Note that other embodiments may use a different GUI, which includes, e.g. additional/different buttons, display panels, images, data items, etc. . . . , arranged on one or more “screens” which are designed to interact with the user and which ultimately serve to display the requested information, which is also satisfactory.

Within this embodiment, where the targeted alcoholic beverage is wine, the product information made available by the system includes an image of the label from the selected bottle, the producer's description of the wine and feedback and ratings provided by other customers who have purchased and consumed the item. Other embodiments of the system which target wine may include other types of product information including tasting notes about that particular vintage, reviews from wine critics, etc. . . . Within embodiments of the system that target other types of alcoholic beverages, the type of product information displayed will be relevant to the targeted alcoholic beverage type. As depicted within FIG. 3, the user may optionally repeat the interactions 260, until which point they are able to make a selection, i.e. as to which specific alcoholic beverage item they would like to purchase. By providing the customer with timely, convenient and relevant point-of-sale information about the alcoholic beverages sold by that specific retail establishment, the system empowers the customer and allows them to make better more informed purchases. As a result, customer satisfaction and sales for the retail establishment and the companies who supply the retail establishment are increased.

Storing Information which Identifies Items Purchased by the User:

Once an item is selected for purchase, the system will keep track of this data such that the user can, at a later point in time, retrieve the list of alcoholic beverage items which were purchased by them in the past. This part of the process begins with interaction 16 where the user 310 chooses a specific item for purchase and the client app 115 passes the ID of the purchased item to the server app 125, as depicted in interaction 17. The server app 125 then generates a SQL statement understood by the DBMS, and passes it to the DBMS 140, such that the item is inserted into the database, as depicted in interaction 18. As one who is skilled in the art of database programming will recognize, a simplified version of the SQL that would be required to insert data for a single item purchased by the customer from a specific establishment on a specific date into the DBMS would be similar to: “Insert into ITEMS_PURCHASED (CUSTOMER_ID, ESTABLISHMENT_ID, PRODUCT_ID, PRODUCT_NAME, DATE) Values (‘5C121A23’, ‘9C124635’, ‘7B435627’, ‘SomeProductName’, ‘2011-10-15’)”, where the ID values ‘5C121A23’, ‘9C124635’, ‘7B435627’ (which are for illustrative purposes only) are used to identify a specific customer, establishment and product respectively. As one who is skilled in the art of database programming will understand, if other embodiments use a different database design, which is also satisfactory, the SQL statement(s) used would have to be adapted to that particular design. This concludes the discussion of the use case defined within FIG. 3.

### Description of Second Use Case:

### Capturing and Storing Feedback Related to Items Purchased:

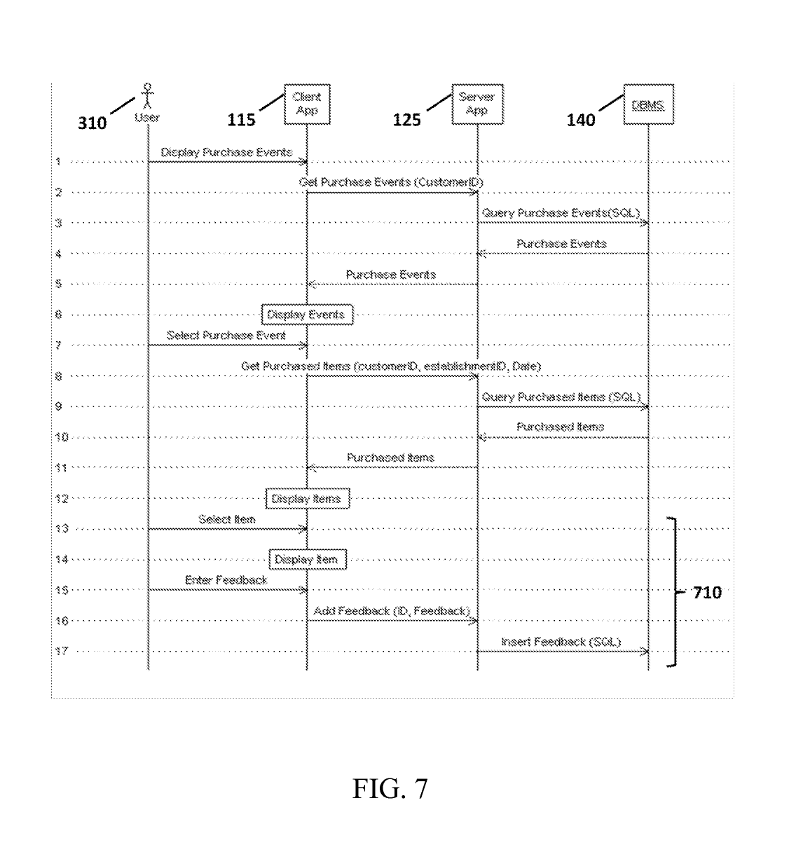

FIG. 7 defines a separate but related use case to the use case just described, i.e. the case where the system is used by the customer to retrieve one or more alcoholic beverage items which were purchased in the past and then using it to provide feedback related to those specific items. The term “feedback” refers to both objective and subjective observations made by the customer related to their consumption of the product as well as to any perceptions formed as a result of that experience. Note that when using the system within the context of this use case, the user does not have to be physically located within the retail establishment in which the items were purchased. They may, for example, be at home when the feedback is provided. The components which participate in this use case are depicted across the top of the diagram, i.e. along the X axis, while the sequence of interactions are listed in chronological order (numbered 1 through 17) on the left side of the diagram, i.e. along the Y axis. Note that other embodiments may specify a different set of interactions, or may choose to order the interactions differently, and yet still achieve the same end result.

Within this embodiment, as depicted within interaction 1 in FIG. 7, the user 310, i.e. the customer, interacts with the client app 115 via a GUI which is displayed on their mobile computing device and requests that the app display one or more past “purchase events” e.g. a specific visit to a restaurant, a specific trip to the grocery store, a specific trip to the liquor store, etc. . . . , where the system was used to make an alcoholic beverage purchasing decision. The client app 115 passes a customer ID which identifies the specific customer within the context of the DBMS from the client app to the server app 125. The server app 125 then passes the customer ID to the DBMS via a SQL statement which the DMBS 140 uses to retrieve the list of past purchase events associated with the customer. As one who is skilled in the art of database programming will recognize, a simplified version of the SQL that would be required to retrieve the past purchase event associated with a specific customer from the DBMS would be similar to: “Select ESTABLISHMENT_ID, DATE from ITEMS_PURCHASED where CUSTOMER_ID=‘5C121A23’ GROUP BY ESTABLISHMENT_ID, DATE” where the customer ID value ‘5C121A23’ (which is for illustrative purposes only) is used to identify the specific customer. As one who is skilled in the art of database programming will understand, if other embodiments use a different database design, which is also satisfactory, the SQL statement(s) used would have to be adapted to that particular design. The DBMS 140 then returns the list of events to the server app 125 who returns the list of past purchase events to the client app 115 as depicted in interaction 4 and 5. The client app 115 then displays the events via the display on the user's mobile computing device as depicted within interaction 6.

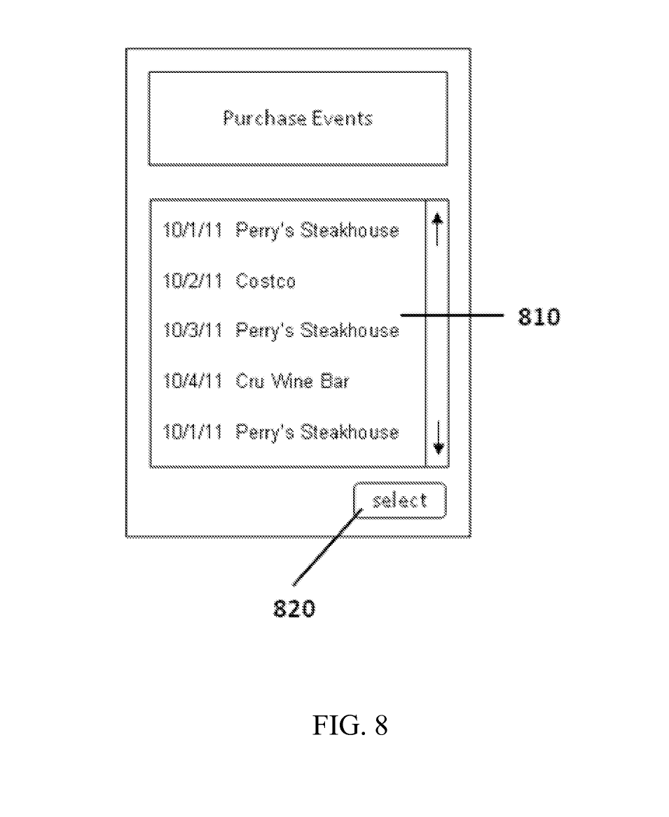

FIG. 8 shows a simplified version of the GUI used by this embodiment to display past purchase events from which the user can select a specific event. The purchase events are displayed within a scrollable list 810. The user 310 selects an item from the list by highlighting it and then clicks the “select” button 820 to retrieve the items purchased during that event. Note that other embodiments may use a different GUI, which includes, e.g. additional/different buttons, display panels, images, data items, etc. . . . , arranged on one or more “screens” which are designed to interact with the user and which ultimately serve to display the past purchase events to the user, which is also satisfactory.

As depicted within interaction 7 in FIG. 7, the user 310 selects a specific past purchase event from the displayed list of events. Using a natural key that uniquely identifies the selected past purchase event, i.e. an ID which identifies the specific customer, an ID which identifies the specific establishment and a value for the specific date and time the purchase was made, the client app 115 requests the purchased items from the server app 125, as depicted within interaction 8. The server app 125, generates a SQL statement which is understood by the DBMS, and uses it to request the data from the DBMS 140, as depicted within interaction 9. The list of purchased items are then returned to the server app 125 by the DBMS 140, as depicted in interaction 10, and the server app 125 then returns the list of purchased items to the client app 115 as depicted in interaction 11, where they are then displayed to the user, as depicted in interaction 12. As one who is skilled in the art of database programming will recognize, a simplified version of the SQL that would be required to retrieve the items associated with a specific purchase event from the DBMS would be similar to: “Select PRODUCT_ID, PRODUCT_NAME from ITEMS_PURCHASED where CUSTOMER_ID=‘5C121A23’ and ESTABLISHMENT_ID=‘9C124635’ and DATE=‘2011-10-15’” where the customer ID ‘9C124635’ and establishment ID ‘9C124635’ and date value (which are for illustrative purposes only) are used to identify the items associated with a specific purchase event. As one who is skilled in the art of database programming will understand, if other embodiments use a different database design, which is also satisfactory, the SQL statement(s) used would have to be adapted to that particular design.

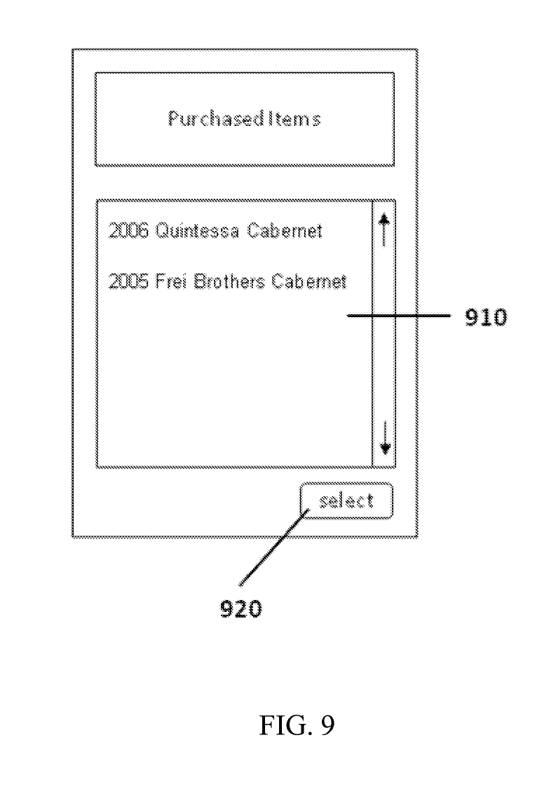

FIG. 9 shows a simplified version of the GUI used by this embodiment to display the list of items purchased during the selected event (when the user clicks the “select” button depicted in FIG. 8). The items are displayed within a scrollable list 910. The user selects an item for which feedback will be entered by highlighting an item within the list and clicking the “select” button 920. Note that other embodiments may use a different GUI, which includes, e.g. additional/different buttons, display panels, images, data items, etc. . . . , arranged on one or more “screens” which are designed to interact with the user and which ultimately serve to display the list of purchased items to the user, which is also satisfactory.

As depicted in FIG. 7, the user 310 selects an item from the displayed list as depicted in interaction 13 and the client app 115 then displays the item as depicted in interaction 14. The user then enters feedback for that specific item as depicted within interaction 15. Within this embodiment the feedback entered includes an objective rating of how well they enjoyed the taste of the purchased alcoholic beverage, whether or not they felt that the beverage was appropriately priced and/or if they would purchase the item again in the future. For other embodiments whose targeted alcoholic beverage type is wine, the feedback might include tasting notes and/or characteristics about the wine including its perceived color, aroma, bouquet, sweetness, finish, etc. . . . Within embodiments that target other alcoholic beverage types, feedback which is relevant to the type of beverage targeted will be collected.

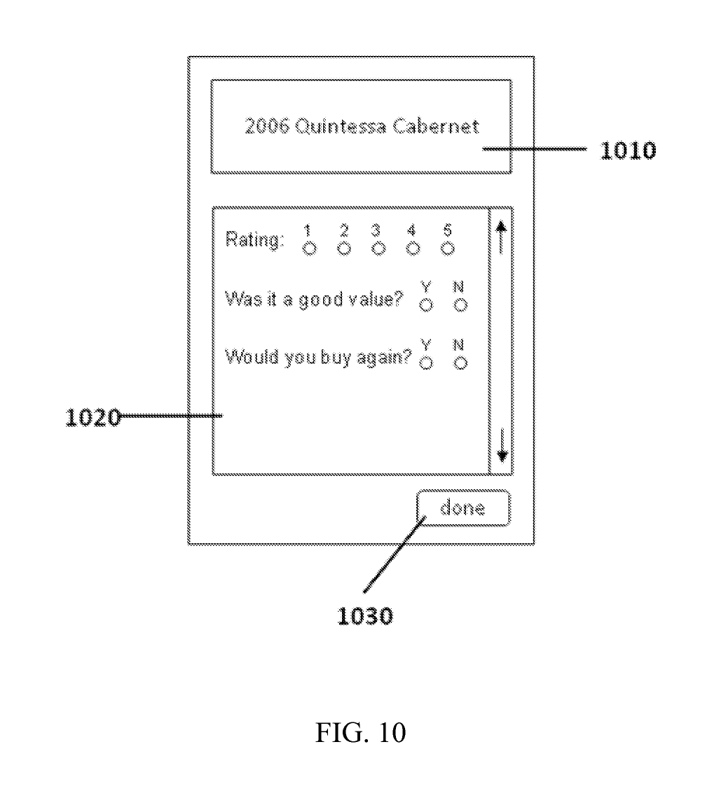

FIG. 10 shows a simplified version of the GUI used by this embodiment to capture feedback for the purchased item. The name of the item selected for which feedback will be entered is displayed at the top of the screen 1010. The user 310 enters feedback within the scrollable area in the center of the screen 1020. Once the feedback has been entered, the feedback is submitted when the user clicks the “done” button 1030. Note that other embodiments may use a different GUI, which includes, e.g. additional/different buttons, display panels, images, data items, etc. . . . , arranged on one or more “screens” which are designed to interact with the user and which ultimately serve to capture feedback for the purchased item, which is also satisfactory.

As depicted within FIG. 7 the feedback entered by the user is transmitted by the client app 115 to the server app 125 along with an ID that uniquely identifies the associated item, as depicted in interaction 16. The server app 125 then generates a SQL statement that is understood by the DBMS and transmits the request to the DBMS 140, as depicted in interaction 17, such that the customer feedback is inserted into the database and associated with the selected item. As one who is skilled in the art of database programming will recognize, a simplified version of the SQL that would be required to insert data for a single item purchased by the customer from a specific establishment on a specific date into the DBMS would be similar to: “Insert into PRODUCT_FEEDBACK (PRODUCT_ID, CUSTOMER_ID, FEEDBACK) Values (‘8B031C21’, ‘5C121A23’, ‘FormattedString’)”, where the product ID ‘8B031C21’ and customer ID ‘5C121A23’ values (which are for illustrative purposes only) are used to identify a specific product and specific customer. The supplied feedback represents a javascript object notation (JSON) formatted string containing name value pairs pairing a criteria type with a criteria value. As one who is skilled in the art of database programming will understand, if other embodiments use a different database design, which is also satisfactory, the SQL statement(s) used would have to be adapted to that particular design. As depicted within FIG. 7, the interactions 710 are optionally repeated by the user 310 until feedback has been entered for all purchased items within the list displayed to the user.

The end result of the process described by this use case is that the collective feedback entered by the patrons of an establishment can then be used by the establishment to determine which items to offer for sale and how to price those items. Factoring customer feedback into the decision process provides for a much better result as compared to basing decisions on sales alone. Additionally, knowing a customer's preference can provide the establishment with an opportunity to suggest other selections with similar characteristics, thereby enhancing customer experience and improving the potential for follow-on purchases. Lastly, customer feedback can be used by other patrons of the establishment to make better more informed purchasing decisions.

Note that while the subject of this specification has been described in connection with one or more exemplary embodiments, it should be appreciated that the embodiment(s) are only examples, and are not intended to limit the claims to the particular forms set forth. The subject of this specification has been described to provide those skilled in the art with a convenient road map for implementing the exemplary embodiment(s), it being understood that various changes may be made in the function and arrangement of elements described in the exemplary embodiment(s) without departing from the scope as set forth in the appended claims and their legal equivalents.

What is claimed is:

1. A method of providing product information to a potential purchaser of alcoholic beverages while the purchaser is shopping within the context of a retail establishment, the method comprising:
a step for identifying the retail establishment within which said purchaser is physically located;
a step for displaying to the purchaser a list of alcoholic beverage items offered for sale by the identified said retail establishment; and
a step for displaying product information which describes an alcoholic beverage item selected by the purchaser from the displayed list of said items offered for sale;
whereby the product information is used by said purchaser to make better, more informed purchasing decisions.

2. The method of claim 1 wherein said retail establishment is a restaurant.

3. The method of claim 1 wherein said retail establishment is a bar.

4. The method of claim 1 wherein said retail establishment is a mass merchandiser.

5. The method of claim 1 further comprising a step for filtering said list of alcoholic beverage items displayed to the purchaser.

6. The method of claim 1 further comprising a step for storing information for later retrieval which identifies one or more alcoholic beverage items purchased by said purchaser.

7. The method of claim 6 further comprising a step for capturing and storing feedback related to said alcoholic beverage items purchased by the purchaser.

8. A mobile computing device for providing product information to a potential purchaser of alcoholic beverages while the purchaser is shopping within the context of a retail establishment, comprising:
a means for identifying the retail establishment within which said purchaser is physically located;
a means for displaying to the purchaser a list of alcoholic beverage items offered for sale by the identified said retail establishment; and
a means for displaying product information which describes an alcoholic beverage item selected by the purchaser from the displayed list of said items offered for sale;
whereby the product information is used by said purchaser to make better, more informed purchasing decisions.

9. The mobile computing device of claim 8 wherein said retail establishment is a restaurant.

10. The mobile computing device of claim 8 wherein said retail establishment is a bar.

11. The mobile computing device of claim 8 wherein said retail establishment is a mass merchandiser.

12. The mobile computing device of claim 8 further comprising a means for filtering said list of alcoholic beverage items displayed to the purchaser.

13. The mobile computing device of claim 8 further comprising a means for storing information for later retrieval which identifies one or more alcoholic beverage items purchased by said purchaser.

14. The mobile computing device of claim 13 further comprising a means for capturing and storing feedback related to said alcoholic beverage items purchased by the purchaser.
